(19) United States
(12) Patent Application Publication
(10) Pub. No.: US 2024/0356369 A1
(43) Pub. Date: Oct. 24, 2024

(54) COMPUTER-IMPLEMENTED METHOD FOR DETERMINING A GRID STABILITY OF AN ELECTRICAL ENERGY GRID, ARRANGEMENT AND COMPUTER PROGRAM PRODUCT

(71) Applicant: Siemens Aktiengesellschaft, München (DE)

(72) Inventors: Amer Mesanovic, München (DE); Andrei Szabo, Ottobrunn (DE); Ulrich Muenz, Princeton, NJ (US); Chris Oliver Heyde, Erlangen (DE); Anatoli Wellhöfer, Lehrberg (DE)

(21) Appl. No.: 18/644,353

(22) Filed: Apr. 24, 2024

(30) Foreign Application Priority Data
Apr. 24, 2023 (EP) 23169561.0

(51) Int. Cl. H02J 13/00; H02J 3/00

(52) U.S. Cl. CPC H02J 13/00028; H02J 3/004; H02J 2203/20

(57) ABSTRACT

A computer-implemented method for determining a grid stability of an electrical energy grid. A communication device receives a dataset with parameters for components of the electrical energy grid and a model generation device generates a root-mean-square model and an electromagnetic transient model based on the parameters. Then a performance device calculates a respective performance property for the root-mean-square model and the electromagnetic transient model and a difference value is determined between the two performance properties by an assessment device. When the difference value exceeds a difference threshold value, the electromagnetic transient model is selected. Otherwise the root-mean-square model is selected. There is also described a corresponding arrangement and a corresponding computer program product.

### CROSS-REFERENCE TO RELATED APPLICATION

This application claims the priority, under 35 U.S.C. § 119, of European Patent Application EP 23169561.0, filed Apr. 24, 2023; the prior application is herewith incorporated by reference in its entirety.

### FIELD AND BACKGROUND OF THE INVENTION

The invention relates to a computer-implemented method for determining a grid stability of an electrical energy grid, an arrangement for implementing such a method, and a computer program product.

Software for a so-called “Supervisory Control and Data Acquisition (SCADA)” system, that is to say, a control center, is known from the product brochure “Intelligent control center technology-Spectrum Power”, Siemens AG 2017, Article No. EMDG-B90019-00-7600. SCADA systems have been known for a long time for monitoring and controlling energy grids (see, Wikipedia permanent link: https://en.wikipedia.org/w/index.php?title=SCADA&oldid=858433181). They involve measured values from sensors, for example from voltage measuring units and current measuring units in the energy grid, being aggregated and transmitted to the control center. In order to control circuit breakers and isolating switches in the energy grid and to actuate energy generators such as power stations, control commands are sent to the energy grid. These control commands are received and processed by “remote terminal units” (RTUs), “programmable logic controllers” (PLCs) and “intelligent electronic devices” (IEDs) in order to actuate the circuit breakers and the isolating switches, etc. To date, there has often been provision in the control center for a local computing center on which the control center software, such as, for example, Spectrum Power, runs. Engineers who are able to monitor the displays of the SCADA relating to the present operating state of the energy grid and, in the event of a fault, to take countermeasures, such as, for example, shutting down a grid section, are provided in the control center around the clock. The control center software is generally operated in a central computer arrangement, which may be in the form of a computing center with processors, data memories and screens, for example. The term “central” in this context is intended to mean that all measurement data from the energy grid and all control commands for the energy grid are processed centrally.

The computer arrangement, or the control center software, may also be produced partly or completely as a cloud application, that is to say, a server arrangement with locally distributed resources for data processing and data storage that are connected by way of a data network, such as, for example, the Internet.

An accompanying phenomenon of ever wider use of distributed energy generation, that is to say for example by photovoltaic installations or wind power installations, is that the ever more numerous local energy generators supplying to the low-voltage and medium-voltage grid make predicting a system state of the energy grid more difficult. The dependency on weather influences also increases because, for example, solar cells are heavily impacted by clouds and wind power installations are heavily impacted by wind strength. These problems also have repercussions for the next-highest voltage level of an energy transmission grid at the high-voltage level, which is therefore more difficult to control and to predict.

To date, load and generation forecasts and/or schedules have generally been used in conjunction with what is known as a “distribution system power flow (DSPF)” to estimate a future grid state. DSPF uses static operating means data, local predictions for energy consumption and energy generation and also dynamic topology information (i.e. which lines are presently connected between the individual components) to compute a forecast voltage absolute value and voltage angle at each network section. Such an approach is known, for example, from the product brochure “Spectrum Power-Aktives Netzwerkmangement” Siemens AG 2016, EMFG-B10104-00. The technical principles are known from the publications “Real-Time Distribution System State Estimation” from Dzafic et al., 2010 IEEE 978-1-4244-7398-4 and “Real-Time Estimation of Loads in Radial and Unsymmetrical Three-Phase Distribution Networks” from Dzafic et al., 2013 IEE 0885-8950.

Carrying out stability simulations is an important task for installation operators that ensures reliable installation operation under different operating conditions. This task is traditionally carried out using the so-called root-mean-square (RMS) or stability simulation, which models the power grid, i.e. grid elements such as power lines, cables and transformers, using algebraic equations. However, models of generators, for example, also contain dynamic states. This approximation, without considering the dynamics, is sufficiently accurate for systems with sufficient conventional generation (large synchronous generators that connect gas, coal or nuclear power plants).

The increasing proportion of inverter-based resources (IBRs) in energy systems such as photovoltaic installations and wind power installations, for example, makes electromagnetic transient (EMT) simulation models necessary for the accurate simulation of dynamic phenomena in such systems, because such installations are usually readjusted much faster than conventional energy generators. This results in dynamic processes that are within the timescale of the changes in capacitances and inductances occurring in the lines of the energy grid.

In contrast to RMS models, EMT models take into account the dynamics of grid elements and generally include more detailed and more accurate models of IBRs. In comparison to RMS simulations, however, EMT simulations require much more time for the simulation to calculate stability on account of the higher number of state equations and advanced models. They also require smaller time steps and the handling of discontinuities.

In the case of systems with a mix of IBRs and conventional components, it is often not known whether an EMT simulation is necessary or whether RMS simulation would be sufficient. In such systems, a conservative approach is usually preferred for safety reasons and EMT simulations are used, resulting in long periods of time for the simulation to be carried out.

By way of example, RMS simulations can be carried out with the PSS-E software, known from the brochure “Dynamic Simulation PSS®E”, Siemens AG 2014. A known software product for RMS and EMT simulations is PSS-SINCAL, for example, which is known from the brochure “PSS®SINCAL Plan reliable distribution networks with precision and speed” from Siemens AG (PSS®, SINCAL® are registered trademarks owned by Siemens AG).

The problem of grid stability under the influence of an increasing number of renewable energy resources that feed in via IBRs is discussed in the publication “Understanding Small-Signal Stability of Low-Inertia Systems” by Markovic et al., IEEE Transactions on Power Systems, Vol. 36, No. 5, September 2021.

To date, only RMS simulation has usually been used for stability simulations in grid planning systems and stability warning systems, since power systems are predominantly of the conventional generation type (e.g. use gas power plants or coal-fired power plants). By way of example, such a stability simulation can be carried out with the SIGUARD DSA software that is known from the brochure “SIGUARD®DSA Dynamic security assessment,” Siemens AG 2020. SIGUARD® is a registered trademark owned by Siemens AG.

EMT-based stability simulation software is currently used primarily for installation certification processes, interconnection requests for large IBRs, or strong dominance of IBRs in the grid. Examples are the systems of Australia, Hawaii, Texas, the UK and Ireland. In these cases, long computing times have to be accepted.

### SUMMARY OF THE INVENTION

Against the background of known methods for analyzing network information, the invention is faced with the object of specifying a method that can be used to choose between an RMS simulation and an EMT simulation comparatively simply, quickly and reliably.

With the above and other objects in view there is provided, in accordance with the invention, a computer-implemented method for determining a grid stability of an electrical energy grid, the method comprising:
receiving by a communication device a dataset with parameters for components of an electrical energy grid; and
generating by a model generation device a root-mean-square model and an electromagnetic transient model on a basis of the parameters;
calculating by a performance device two performance properties, being a performance property for a root-mean-square model and a performance property of an electromagnetic transient model; and
determining by an assessment device a difference value between the two performance properties, wherein, when the difference value exceeds a difference threshold value, selecting the electromagnetic transient model, and otherwise selecting the root-mean-square model.

In other words, the invention provides simulation users with support when deciding between EMT and RMS simulations. A decision tool is proposed, which automatically determines whether an EMT simulation is required or whether an RMS simulation is sufficient, thereby reducing simulation time and hardware requirements.

The use of the novel system enables potential savings of a factor of 10 in terms of the required computing time compared with the exclusive use of EMT. This reduces the processing time for different studies and increases the capacity of studies. Since the proposed method is used for stability simulations during operation, it allows a greater number of simulations to be carried out in advance, and therefore a greater number of scenarios to be considered than before. This allows an improved response to faults, which increases system safety.

The invention may advantageously be used for electrical energy supply grids (medium voltage or low voltage) or energy transport grids (high voltage). By way of example, a medium-voltage grid has a rated voltage of 1 kV to 52 kV. By way of example, a low-voltage grid has a rated voltage of at most 1 kV. By way of example, a high-voltage grid has a rated voltage of more than 20 kV.

By way of example, a communication device is designed for data communication according to the TCP/IP protocol, another common Internet communication protocol, or the communication standard IEC 61850.

A device within the meaning of the invention has, for example, processors, processor cores, GPUs, data memories and optionally an output device such as a screen. It is also possible for the device to be produced partly or completely as software. Provision can also be made for using a cloud application, that is to say a software component for execution on a server arrangement with locally distributed resources for data processing and data storage that are connected by way of a data network, such as, for example, the Internet.

A grid operator typically estimates the actual state of its installations at regular intervals on the basis of measurements from the real energy grid. The result of the estimate is used to update the model of the system, e.g. to the present generation mix of conventional and renewable generation. Based on the updated model, a decision can be made as to whether an EMT or RMS simulation is required.

Subsequently, various eventualities and scenarios are simulated using software such as SIGUARD®DSA (owned by Siemens Aktiengesellschaft) mentioned above. On the basis of the results of the simulation, preventive measures, such as setpoint value changes, for example, can be taken to maintain safe operation of the installation. The invention contributes to reducing the required computing time and outlay to complete this control loop.

The method according to the invention can also be used during offline planning studies and not only for in-the-loop simulations. The operating points for the comparison may also be calculated automatically by applying faults to the system input. The calculation of EMT/RMS models and performance characterizations can be carried out in parallel in order to speed up the simulation.

It is an essential aspect of the invention that the decision regarding the use of RMS or EMT is not carried out on the basis of complex simulations that would be time-consuming and would have a large computing requirement. Instead, a purely analytical comparison of the two methods is carried out so as to determine whether RMS is sufficient or whether the more complex EMT has to be used.

According to the invention, parameters of all components in the energy systems are recorded:
parameters of all generators and loads for EMT and RMS models
parameters of network elements such as cables, power lines, transformers
parameters of flexible alternating current transmission systems (FACTS), etc.

This first step can be complex in practice, but is known in the art.

An RMS model Sᵣ of the system is constructed on the basis of the parameters:

$${\dot{x}}_{r} = {f}_{r} ( {x}_{r} , u ) , 0 = {h}_{r} ( {x}_{r} , u )$$

where, xᵣ denotes constant states of the system, u are external inputs into the system, fᵣ is the system model in state space notation and h, represents algebraic equations in the system.

An EMT model of the system Sₑ is constructed analogously:

$${\dot{x}}_{e} = {f}_{e} ( {x}_{e} , u ) , 0 = {h}_{e} ( {x}_{e} , u )$$

The notation here is analogous to that of the RMS definition.

In one preferred embodiment of the computer-implemented method according to the invention, for the components, at least one of the following components is used: line, cable, transformer, switching device, generator, load, flexible alternating current transmission system (FACTS).

In a further preferred embodiment of the computer-implemented method according to the invention, the selected model is used by a simulation device for a stability analysis of the energy grid.

In a further preferred embodiment of the computer-implemented method according to the invention, on the basis of the stability analysis, countermeasures for stabilizing the grid state are ascertained and transmitted as control commands to controllable operating means in the energy grid by means of a grid control device.

In a further preferred embodiment of the computer-implemented method according to the invention, both models are linearized at selected operating points for the calculation of the performance properties. The methods for creating linearized EMT and RMS models are well known and can be found, for example, in the textbook “Power System Stability and Control, 2nd Edition” by Kundur and Malik, ISBN: 9781260473544, 2022 McGraw Hill.

The selection of operating points, which is described in more detail below, depends, for example, on present measured values, the system state, experience of the user, historical values, etc.

The operating points are characterized by the system input u; and the dynamic models of the power system S_{r,i} and S_{e,i}, where i indicates an operating point i∈[1 . . . Nₒₚ].

For i∈[1 . . . Nₒₚ], Sri needs to be linearized to obtain S_{r,i,lin}.

$${\dot{x}}_{r , i} = {A}_{r , i} {x}_{r , i} + {B}_{r , i} {u}_{i}$$

S_{e,i} needs to be linearized to obtain S_{e,i,lin}.

$${\dot{x}}_{e , i} = {A}_{e , i} {x}_{e , i} + {B}_{e , i} {u}_{i}$$

The performance property calculation will be discussed below.

For performing the modal analysis, Art is determined, which corresponds to the set of relevant “poles” or eigenvalues of the system matrix A_{r,i} for i∈[1 . . . Nₒₚ]. This may be carried out using known methods, such as those known from the textbook mentioned above, for example. In an analogous manner, a set of relevant poles or eigenvalues for i∈[1 . . . Nₒₚ] may be determined for Λ_{e,i}. Λ_{r,i} and Λ_{e,i} must be of the same length in this case.

If the norm performance method is intended to be used instead, then H_{∞}(S_{r,i,lin}), H_{∞}(S_{e,i,lin}) or H₂(S_{r,i,lin}), H₂(S_{e,i,lin}) is determined for i∈[1 . . . Nₒₚ]. Prior art methods are known for this purpose.

Alternatively, the performance of a singular value curve may also be taken into account, and therefore singular value curve sets σ_{r,i}(w) and σ_{e,i}(w)) are used for S_{r,i,lin}, S_{e,i,lin}, i∈[1 . . . Nₒₚ] using known approaches (link: https://de.mathworks.com/help/control/ref/Iti.sigma.html). The curve sets are vector functions that are a function of the system input frequency (not to be confused with the physical grid frequency).

Finally, the text that follows focuses on the determination of the performance characteristics. The properties of Sᵣ and Sₑ are compared. If there is a large difference between them, the EMT model is necessary for the simulation. Otherwise, the RMS model is sufficient.

The comparison is carried out differently for the different performance characterizations.

For a modal analysis or pole performance, a calculation is carried out for each i∈[1 . . . Nₒₚ] pole that corresponds to the same states Λ_{r,i} and Λ_{e,i}. The following applies: If ∥λ_{r,i,j}−λ_{e,i,j}∥<∈ for all j∈[1 . . . N_{P,i}] and i∈[1 . . . Nₒₚ], where e is a previously established threshold value and N_{P,i} is the number of relevant poles at the i-th operating point, the RMS simulation is sufficient for the simulation of the system.

For a norm performance, the following is calculated for each i∈[1 . . . Nₒₚ]:|H_{∞}(S_{r,i,lin})−H_{∞}(S_{e,i,lin})|. If the maximum difference is less than a previously established threshold value, the RMS model is sufficient.

If a singular value curve is intended to be used instead, the singular value curve sets are calculated for each i∈[1 . . . Nₒₚ]:σ_{r,i}(ω) and σ_{e,i}(ω): if ∥σ_{r,i}(ω_{i,k})−σ_{e,i}(ω_{i,k})|<η for ωᵢₖ∈Ωᵢ and i=[1 . . . Nₒₚ], where n is a previously established threshold value and Nix is the set of frequencies for which the singular value curve sets σ_{r,i}(ω) and σ_{e,i}(ω) are calculated, the RMS calculation may be used for this system.

In a further preferred embodiment of the computer-implemented method according to the invention, the selected operating points comprise the eigenvalues of the system matrix for determining the grid state, wherein the eigenvalues correspond to at least one of the following grid parameters: frequency, voltage angle of a generator.

In a further preferred embodiment of the computer-implemented method according to the invention, a modal analysis is carried out for the calculation of the performance properties for both models.

In a further preferred embodiment of the computer-implemented method according to the invention, the selected operating points are determined on the basis of at least one of the following system norms: H₂ norm, H_{∞} norm. By way of example, the H₂ norm is known from the website MathWorks (link: https://de.mathworks.com/help/ident/ref/dynamicsystem.norm.html). By way of example, the H_{∞} norm is known from the website MathWorks (link: https://de.mathworks.com/help/robust/ref/dynamicsystem.hinfnorm.html;jsessioni d=1e1048fc1adfd7a3b225a0a9ce80).

In a further preferred embodiment of the computer-implemented method according to the invention, an analysis of the norm performance is carried out for the calculation of the performance properties for both models.

In a further preferred embodiment of the computer-implemented method according to the invention, the selected operating points comprise singular value curves of a frequency response.

In a further preferred embodiment of the computer-implemented method according to the invention, an analysis of the singular value curves is carried out for the calculation of the performance properties for both models.

Against the background of known arrangements for determining a grid stability of an electrical energy grid, the invention is faced with the object of specifying an arrangement that can be used to choose between an RMS simulation and an EMT simulation comparatively simply, quickly and reliably.

The invention achieves this object by way of an arrangement as claimed, an arrangement as claimed, and a corresponding computer program product. The same advantages as explained at the outset for the method according to the invention also result analogously.

Against the background of known computer program products for analyzing network information, the invention is also faced with the object of specifying a computer program product that can be used to choose between an RMS simulation and an EMT simulation comparatively simply, quickly and reliably.

Other features which are considered as characteristic for the invention are set forth in the appended claims.

Although the invention is illustrated and described herein as embodied in a computer-implemented method for determining a grid stability of an electrical energy grid, arrangement and computer program product, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 shows an overview of the invention;

FIG. 2 shows an exemplary flowchart of a method according to the invention; and

FIG. 3 shows an example of a comparison of RMS and EMT simulations.

### DETAILED DESCRIPTION OF THE INVENTION

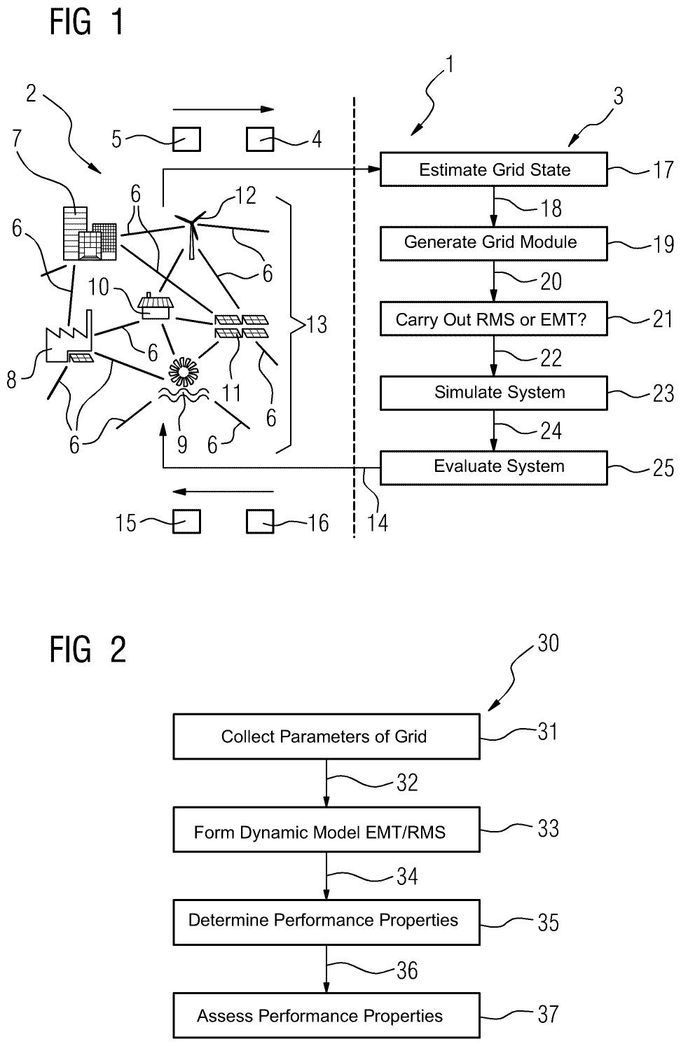

Referring now to the figures of the drawing in detail and first, in particular, to FIG. 1 thereof, there is shown a schematic overview 1 of the invention. An energy grid 2 is shown on the left-hand side of the image and a method 3 according to the invention, which is carried out by an energy grid operator, is shown on the right-hand side of the image.

By way of example, energy generators such as photovoltaic installations 11, wind power installations 12 and hydropower plants 9 are present in the energy grid. These are connected to energy consumers such as houses 10, factories 8 and office buildings 7 in the energy grid via lines 6. The above-mentioned generators and consumers of electrical energy, together with lines 6, form an electrical energy grid 13. In the energy grid 13, sensors and operating means such as switching devices are provided (not shown), which transmit measured values 4 and status signals 5 (for example open/closed switch position) to the method according to the invention.

According to the method according to the invention, a grid state is estimated in step 17. The grid state includes voltage values at the nodes in the electrical energy grid, switch positions and energy generation values, which are provided via a data communication connection 18. In the next step 19, a model of the electrical energy grid is generated. This provides model parameters for the next step 21 via a data communication connection 20. In step 21, which is the core of the present invention, a decision is made by means of an automated method as to whether an RMS simulation or an EMT simulation is carried out. The result (EMT or RMS) is received via a data communication connection 22 in step 23. A simulation of the system based on EMT or RMS is performed depending on the choice in step 21. The simulation results are provided via a data communication connection 24 for further evaluation in step 25. By way of example, stability problems in the electrical energy supply grid 13 can be detected because, for example, the intended rated frequency is not complied with. On the basis of these findings, for example, countermeasures may be taken in an automated or partly automated manner. By way of example, preventive countermeasures, such as changes of switch positions 15 or changes in the tap position for controllable local network transformers 16, are transmitted as control commands to controllable operating means in the energy grid 13 via a data communication connection 14.

FIG. 2 shows an example of a method 30 according to the invention, in which the parameters for components of an electrical energy grid are collected in the first step 31. The components comprise, for example, lines, cables, transformers, switching devices, generators, loads, flexible alternating current transmission systems (FACTS). The parameters are provided via data communication 32 to step 33, in which a respective dynamic model is formed as an EMT model and an RMS model. The complete EMT and RMS models are provided via data communication 34 to step 35. In step 35 a respective performance property is determined for the RMS model and the EMT model. The performance properties of the EMT and the RMS model are provided via data communication 36 to step 37. Finally, in step 37, the performance properties are assessed, wherein a difference value is determined in the context of an assessment of the system properties for the EMT and the RMS models. If a large deviation or a large difference value between the two models is ascertained, an EMT simulation is required for all subsequent steps. Otherwise, the RMS simulation is sufficient because it provided similar values to the EMT simulation.

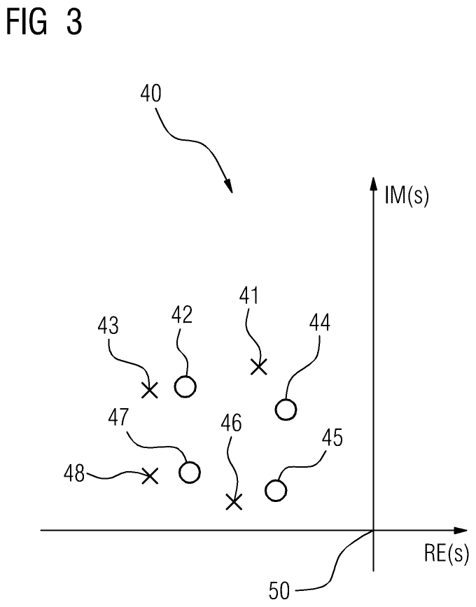

FIG. 3 shows an example of a comparison of RMS and EMT simulations. In example 40, results of the RMS and EMT simulations are plotted on a real plane RE and an imaginary plane IM in each case in relation to the origin 50 of the system. The RMS data points are denoted by a circle, while the EMT data points are denoted by a cross. The 6 data points relate to three pairs of results for RMS and EMT simulations, in which different eigenvalues of the system matrix were considered for the system state calculation. By way of example, data points 41 and 44, 45 and 46, 47 and 48, and 42 and 43 each form a pair.

For each of the four pairs, a distance between the RMS result and the EMT result (i.e., the cross and the circle) may be determined in the form of a difference value. This difference value is further evaluated according to the invention in order to establish whether the results between RMS and EMT with respect to the present energy grid deviate from one other by more than a permissible threshold value. If this is the case, the difference in the calculation between EMT and RMS is so great that only EMT should be used for the calculation of countermeasures with respect to the grid stability. If, however, the RMS and EMT results are close to one another (as in the present case), the RMS simulation, which is able to be calculated much faster, is sufficient to determine the grid stability.

1. A computer-implemented method for determining a grid stability of an electrical energy grid, the method comprising:
receiving by a communication device a dataset with parameters for components of an electrical energy grid; and
generating by a model generation device a root-mean-square model and an electromagnetic transient model on a basis of the parameters;
calculating by a performance device two performance properties, being a performance property for a root-mean-square model and a performance property of an electromagnetic transient model; and
determining by an assessment device a difference value between the two performance properties, wherein, when the difference value exceeds a difference threshold value, selecting the electromagnetic transient model, and otherwise selecting the root-mean-square model.

2. The computer-implemented method according to claim 1, wherein the components include at least one component from the group consisting of a line, a cable, a transformer, a switching device, a generator, a load, and a flexible alternating current transmission system.

3. The computer-implemented method according to claim 1, which comprises using the model selected in the selecting step by a simulation device for a stability analysis of the energy grid.

4. The computer-implemented method according to claim 3, which comprises, based on the stability analysis, ascertaining countermeasures for stabilizing the grid state and transmitting the countermeasures as control commands from a grid control device to controllable operating means in the energy grid.

5. The computer-implemented method according to claim 1, which comprises linearizing the electromagnetic transient model and the root-mean-square model at selected operating points for calculating the performance properties.

6. The computer-implemented method according to claim 5, wherein the selected operating points comprise eigenvalues of the system matrix for determining the grid state, the eigenvalues corresponding to at least one grid parameter selected from the group consisting of a frequency and a voltage angle of a generator.

7. The computer-implemented method according to claim 6, which comprises carrying out a modal analysis for a calculation of the performance properties for the electromagnetic transient model and the root-mean-square model.

8. The computer-implemented method according to claim 5, which comprises determining the selected operating points on a basis of at least one norm selected from the group of system norms consisting of H₂ norm and H_{∞} norm.

9. The computer-implemented method according to claim 8, which comprises carrying out an analysis of a norm performance for the calculation of the performance properties for the electromagnetic transient model and the root-mean-square model.

10. The computer-implemented method according to claim 5, wherein the selected operating points comprise singular value curves of a frequency response.

11. The computer-implemented method according to claim 10, which comprises carrying out an analysis of the singular value curves for the calculation of the performance properties for the electromagnetic transient model and the root-mean-square model.

12. An arrangement for determining a grid stability of an electrical energy grid, the arrangement comprising:
a communication device configured to receive a dataset with parameters for components of an electrical energy grid; and
a model generation device configured to generate a root-mean-square model and an electromagnetic transient model on a basis of the parameters;
a performance device configured to calculate a respective performance property for the root-mean-square model and the electromagnetic transient model; and
an assessment device configured to determine a difference value between the performance property of the root-mean-square model and the performance property of the electromagnetic transient model, and, when the difference value exceeds a difference threshold value, selecting the electromagnetic transient model or otherwise selecting the root-mean-square model.

13. The arrangement according to claim 12, wherein said performance device is configured to linearize the root-mean-square model and the electromagnetic transient model at selected operating points for a calculation of the performance properties.

14. A non-transitory computer program product, comprising instructions which, when the program is executed by a computer, cause the computer to carry out the method according to claim 1.
